(19) United States
(12) Patent Application Publication
(10) Pub. No.: US 2006/0037505 A1
(43) Pub. Date: Feb. 23, 2006

(54) Lithographic printing memebers and a method and a system for preparation of lithographic printing members

(76) Inventors: Avigdor Bieber, Ra'anana (IL); Zeev Savion, Kibbutz Hanita (IL); Svetlana Mosheev, Nahariya (IL); Michael K. Karp, Petah Tikva (IL); Gal Tamir, D. N. Akko (IL); Dany Eisenstadt, Kefar Veradim (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/519,478

(22) PCT Filed: Aug. 7, 2003
(86) PCT No.: PCT/IL03/00652

§ 371 Date: Dec. 30, 2004

Related U.S. Application Data
(60) Provisional application No. 60/401,336, filed on Aug. 7, 2002.
(60) Provisional application No. 60/455,392, filed on Mar. 18, 2003.

(51) Int. Cl. B41N 1/00

(52) U.S. Cl. 101/457

(57) ABSTRACT

Lithographic printing members and a method and system for fabricating them is provided. The printing member may comprise a base layer, a laser-absorbing layer, which may be a gradient solid dispersion of metal and metal-oxide areas, and a coating layer. The concentration ratios between the metal and the metal-oxide vary throughout a thickness of the laser-absorbing layer and the coating layer and the base layer have different affinities for ink. The method of fabricating the printing member may comprise preparing on demand for a single use a liquid-based coating material, pouring the coating material onto a substrate that may comprise a base layer and a laser-absorbing layer and laminating a form film onto the liquid-based coating material to form a coating layer.

### BACKGROUND OF THE INVENTION

In offset lithographic printing, a standard printing plate may comprise at least two layers having different affinities for ink or ink-repellent fluid. For example, a printing plate may comprise an ink-accepting oleophilic base layer, a laser-radiation absorbing metal layer, and a top ink-repelling oleophobic layer. Before printing, the printing plate is imaged, off-press or on-press, by selective laser ablation. Usually an infrared or near infrared laser is used as a relatively high energy is required to image such a printing plate due to the reflectivity and heat-conductivity of the metal layer. Other multi-layered and more complicated printing plates are also in use.

The process of plate-making is expensive, complicated and requires a large facility. As such, the printer cannot make his own printing plates at his workshop and is required to buy and stock printing plates from a plate-making supplier. Furthermore, the printer is required to stock many different printing plates to be able to supply his clients demand for standard and non-standard sizes of printed images.

Therefore there is a need in the art for a printing member that is relatively easy to manufacture and that may be imaged with reduced laser energy.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are simplified illustrations of a system for preparing on-demand blank lithographic printing plates according to some embodiments of the present invention;

FIGS. 2, 3 and 4 are schematic illustrations of exemplary printing members according to some embodiments of the present invention; and

FIG. 5 is an exemplary illustration of a laser-absorbing layer of a printing member according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method of directly producing a printing media printing plate) may involve using a dispensing and coating desktop device. A coating material is prepared prior to starting of the coating process by dispensing the necessary materials from a multiple-compartments cartridge and mixing the required quantities of the formulation ingredients materials into a liquid based material.

In other embodiments, the ingredients of the coating material may be mixed in advance, and then may be put into a single-compartment cartridge.

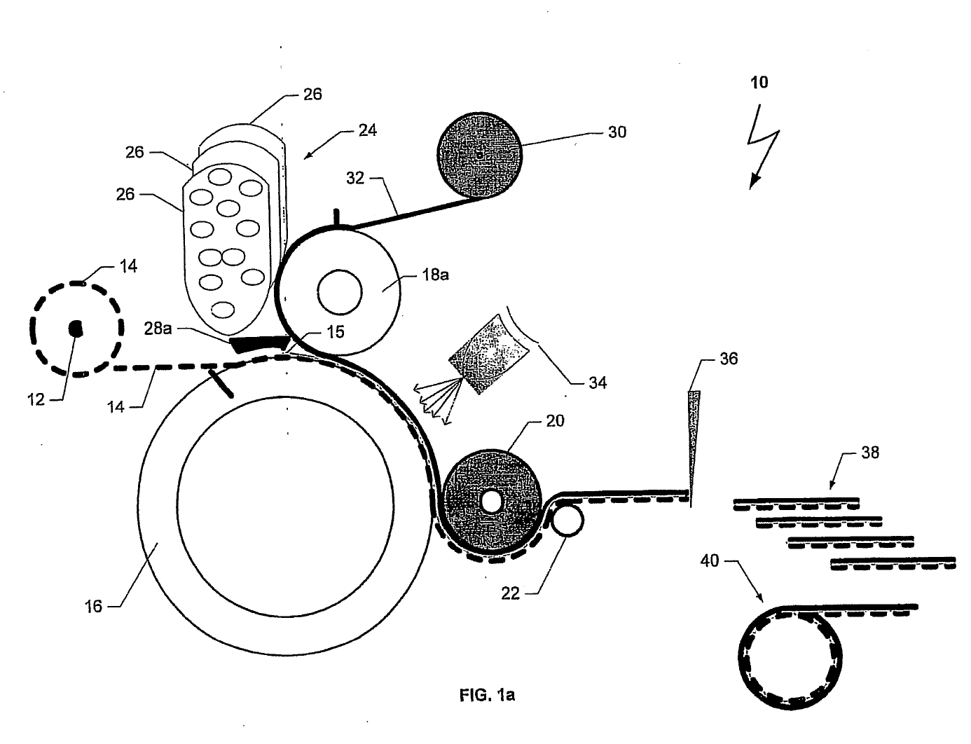

Reference is now made to FIG. 1A, which is a schematic cross sectional view of a system for on-demand plate-making of blank lithographic printing plates according to exemplary embodiments of the present invention. It should be noted that the terms “printing member” and “printing plate” are used interchangeably throughout the specifications and the claims. A plate-min system 10 may comprise a substrate-feed roller 12 able to carry a substrate 14 continuously wound in the form of a roll, guiding rollers 16, 18A, and 20 to advance unwound substrate 14 in a predetermined direction at a controlled speed, and a pulling cylinder 22 actuated by a controlled motor (lot shown) to pull substrate 14 at the required speed. The width of substrate 14 may be substantially similar to a standard paper size such as A1, A2, A3, A4, B2, B3 and B4.

According to other embodiments of the present invention, substrate-feed roller 12 may be replaced by a sheet feeder mechanism and substrate 14 may be then in a form of substrate sheets.

Although three guiding rollers are shown in FIG. 1, it should be understood to a person skilled in the art that the scope of the present invention is not limited in this respect and system 10 may comprise any number of guiding rollers and pulling cylinders, as known in the art. Alternatively, other transporting mechanisms, as known in the art may be used.

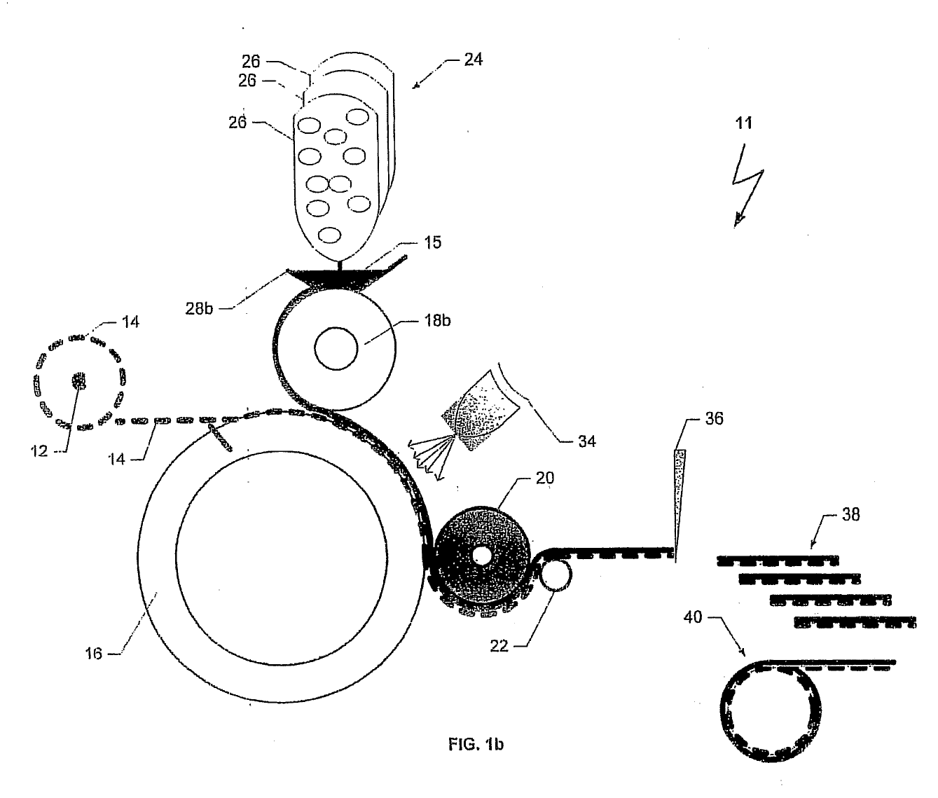

Substrate 14 may include a polymer substrate, such as, but not limited to, polyester, polycarbonate and PVC. Substrate 14 may further comprises laser-absorbing layer and/or primer layer. Exemplary embodiments of substrate 14 are described hereinbelow with respect to FIGS. 2-4.

System 10 may further comprise a mixing and coating unit 24 to prepare on-demand a coating material and to apply the coating material onto substrate 14. Unit 24 may comprise one or more cartridges 26, each able to contain separately one or more ingredients of the coating formulation and an applicator 28A to mix the ingredients and to apply the material over substrate 14 forming a coating layer 15. Applicator 28A may comprise a slot a manifold or a single aperture through which the liquid coating material may be applied. Unit 24 may further comprise a controller (not shown) to control the quantities of each component, as known in the ar

Although three cartridges 26 are shown in FIG. 1, it should be understood to a person skilled in the art that the scope of the present invention is not limited in this respect and system 10 may comprise any suitable number of cartridges.

Optionally, system 10 may comprise an ironing lamination mechanism to enable laminating a form film onto substrate 14 such ha the liquid coating material is trapped between the substrate 14 and the form layer to create the coating layer 15. The form film may reduce the ultraviolet energy required to cure the coating material by isolating the coating material from the air thus preventing oxygen inhibition. The lamination mechanism may comprise a film-feed roller 30 to carry a form film 32 continuously wound in the form of a roll. According to other embodiments of the present invention, film-feed roller 30 may be replaced by a sheet feeder mechanism and form film 32 may be then in the form of sheets. Form film 32 may be a polymeric film with low surface energy. Non-limiting examples of the form film may be polyethylene, polypropylene, polytetrafluoroethylene and silicone-coated polyester.

System 10 may comprise a conditioning unit 34, such as for example an ultraviolet (UV) curing lamp to condition the coating material, an infrared (IR) heater, a catalytic curing unit and a moisture-curing unit.

System 10 may comprise a cutting unit 36 to cut the coated substrate into a printing plate according to the required specifications, and one or more trays 38 to receive the printing plates. Cutting unit may cut the roll in both dimensions into sheets having a predefined length and width. Alternatively or additionally, system 10 may comprise a take-up roller 40 able to rewind coated and optionally laminated substrate 14 to a ping member roll.

The transporting path of substrate 14 may be as follows: A coating material may be prepared by dispensing predetermined quantities of ingredients contained in multiple-compartment cartridge 26 and mixing them into a liquid-based coating material. Substrate 14 may be unwound as feed roller 12 is rotated. The coating material, which is a fluid may be applied to or poured over unwound substrate 14 or over form film 32. The fluid may be poured at a predefined flow over substrate 14 or over form film 32 in proximity to the junction of rollers 16 and 18A where form film 32 and substrate 14 converge.

In substantial synchronization to the movement of substrate 14, form film 32 may be unwound as film feed roller 30 is rotated. Both substrate 14 and film 32 may be fed between guide rollers 16 and 18A together with the liquid-based coating material. Rollers 16 and 18A may adhesively press film 32 onto substrate 14 such that the liquid coating material is trapped between substrate 14 and form film 32 to form coating layer 15. The thickness of the coating layer 15 may be in the range between 1 and 5 microns. According to some embodiments of the present invention, the thickness of the coating layer may be less the one micron. According to other embodiments of the present invention, the thickness of the coating layer may be more than 5 micron.

It should be understood, however, to a person skilled in the art that the scope of the present invention is not limited to coating by the ironing lamination method described above and other coating methods such as for example wet lamination may be used. In the wet lamination method, system 10 may comprise a coating element (not shown). Non-limiting examples of such a coating element may be a silkscreen, a wire-wound rod, an offset coating unit an anilox roller, an air blade and a gravure roller.

The coating element may be installed in proximity to substrate-feed roller 12. The coating element may receive the liquid-based coating material from applicator 28A and may create a substantially uniform coating layer having predefined desired properties prior to the lamination operation.

The laminated printing plate may then be conditioned by an Ultraviolet lamp or any other suitable conditioning method. Non-limiting examples of suitable conditioning methods according to the present invention may include thermal condition catalytic conditioning, and moisture curing.

The printing plate is then guided by roller 20 and pulled by pulling cylinder 22 into cutting unit 36. Cutting unit 36 may cut the printing plate roll into sheets at a desired size and the sheets may be delivered into trays 38. Alternatively the printing plate may be rewound to a printing member roll by take-up roller 40.

Reference is now made to FIG. 1B, which is a schematic cross sectional view of a system for on-demand plate-making of blank lithographic printing plates according to other exemplary embodiments of the present invention. Elements of these embodiments, which are similar to elements previously described with respect to FIG. 1A, are similarly designated and will not be further described. The plate-making system 11 of FIG. 1B is similar to system 10, except that in system 11 a coating unit 18B replaces film-feed roller 30 and roller 18A. Coating unit 18B may be a silkscreen, a wire-wound rod, an offset coating unit, an anilox roller, an air blade and a gravure roller and any other coating element as known in the art.

In these embodiments, the coating unit 18B may receive the liquid-based coating material from cartridges 26 via applicator 28B and may uniformly coat substrate 14 at the junction of rollers 181B and 16 where substrate 14 and form film 32 converge, thus forming coating layer 15.

According to some embodiments of the present invention, substrate 14 may be laminated over a metal base, such as, for example aluminum, to improve the mechanical strength of the printing member.

According to some embodiments of the present invention, on-demand plate-making system 10 or 11 may be a part of a printing machine having an on-press imaging unit. According to other embodiments of the present invention, on-demand plate-making system 10 may be a part of a direct computer-to-plate (CTP) machine.

Reference is now made to FIGS. 2, 3 and 4, which illustrate the layers of exemplary printing members according to some embodiments of the present invention. The exemplary printing members 100, 200 and 300, which may be produced by system 10 or 11, comprise substrate layer 14 and coating layer (ablatable layer) 15.

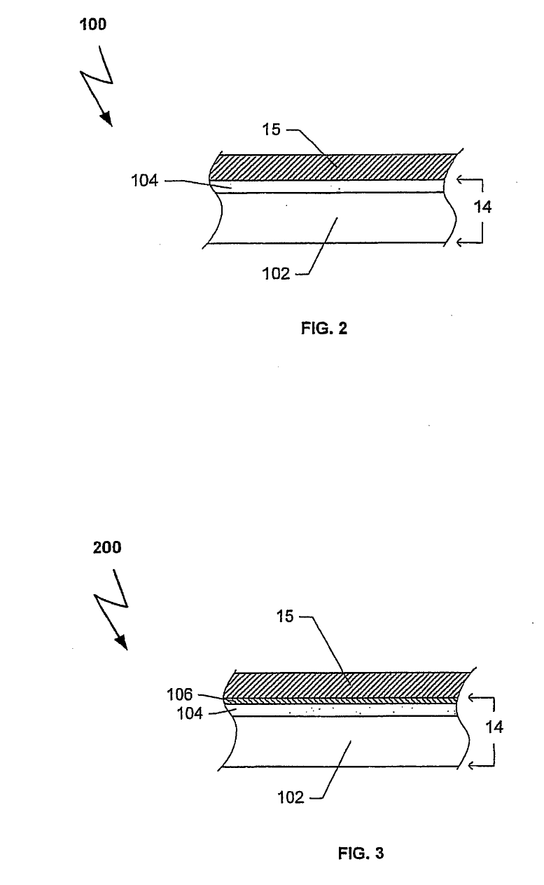

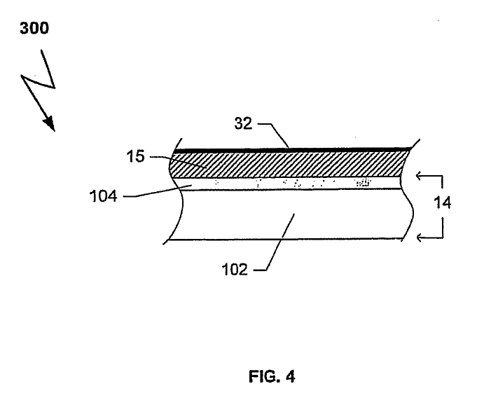

Referring to FIG. 2, substrate layer 14 may comprise a base layer 102 and a laser-absorbing layer 104. FIG. 3 is similar to the embodiment of FIG. 2, except that substrate layer 14 may further comprise a primer 106 above laser-absorbing layer 104 to improve the adhesion of coating layer 15 to substrate 14. FIG. 4 is similar to the embodiment of FIG. 2, except that printing member 300 may further comprise form film 32 over coating layer 15. It should be understood that exemplary printing plates described with respect to FIG. 2-5 are exemplary only and do not limit the scope of the present invention and additional layers may be added to those structures. Also, throughout the specification and the claims, the description “a first layer over a second layer” does not exclude having one or more intermediate layers interposed between the first and the second layer.

Base layer 102 may be a polyester layer having ink-accepting oleophilic properties. Non-limiting examples of oleophilic base layer 102 may be polyvinylchloride (PVC), polycarbonate and polyethylene terephthalate film. The thickness of the oleophilic layer 102 may be, for example, in the range between 0.001 inch and 0.02 inch.

Primer layer 106 may comprise a carboxy-functional vinyl terpolymer, such as, but not limited to, the terpolymer sold under the trade name UCAR Vinyl VMCH by Union Carbide/Dow.

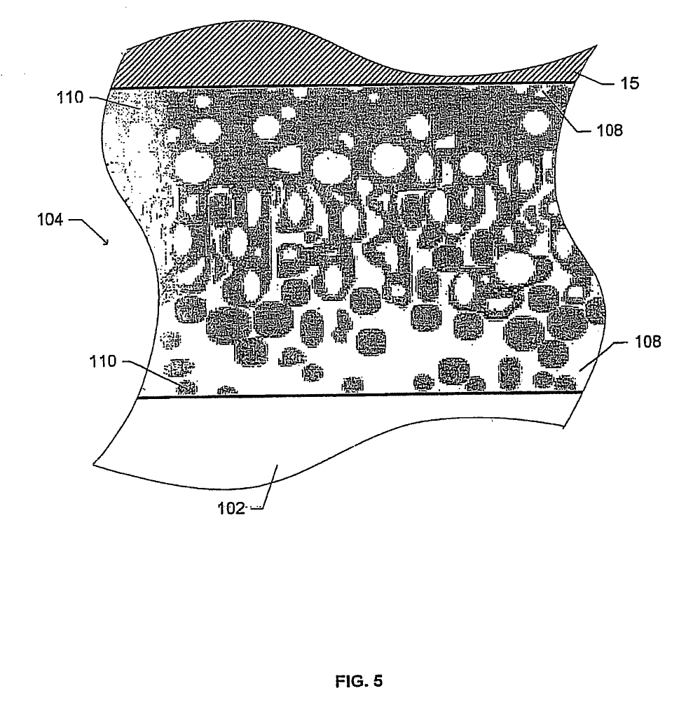

Referring to the laser-absorbing layer 104, FIG. 5 is an illustration of the structure of an exemplary laser-absorbing layer according to some embodiments of the present invention. Laser-absorbing layer 104 may be a gradient solid dispersion of one or more metals and one or more metal-oxides forming a metal/metal-oxide layer where at least some of the areas may be characterized by a non-stoichiometric ratio between the metal and the oxygen. The layer may be constructed such that the concentration ratios of metal-oxides to metals throughout its thickness vary continuously or in steps forming a gradient of metal/metal-oxide concentrations.

The metal/metal-oxide layer may be deposited over base layer 102 using a metal vapor deposition process, in which a controlled amount of oxygen is introduced into the metal vapor stream to create the gradients solid dispersion. According to some embodiments of the present invention, the thickness of laser-absorbing layer may be, for example, in the range of 200 to 6000 Angstroms. Alternatively, a film comprising a base layer 102 and a metal/metal-oxide layer 104 may be commercially available. Such exemplary suitable pre-coated films are manufactured by Hanita Coating LP of Israel, under the trade names B05012P and B0361P.

The ratios of the metal to the oxide within the non-stoichiometric metal-oxide may vary at different domains throughout the thickness of the layer. According to some exemplary embodiments of the present invention, the non-stoichiometric ratio of the metal to the oxide is higher at the bottom of the layer 104 in comparison to the top of the layer. The non-stoichiometric domains of the metal-oxide may improve the absorption of the laser radiation and may accelerate the exposing process.

Non-limiting examples of a metal/metal-oxide layer may be an aluminum/aluminum oxide layer, nickel/nickel-oxide, magnesium/magnesium-oxide, zinc/zinc-oxide, chrome/chrome-oxide, titanium/titanium-oxide, iron/iron-oxide, and copper/copper-oxide. The metal/metal-oxide layer may comprise a combination of more one metal such as, for example an aluminum/copper/aluminum-oxide layer.

Referring back to FIG. 5, areas 108 represent metal domain and areas 110 represent metal-oxide domains. At the bottom of layer 104 closer to base layer 102, the concentration of the metal is higher than the concentration of the metal-oxide and small islands of metal-oxide 110 may be surrounded by areas of metal 108. Near the upper surface of the metal/metal-oxide layer, the concentration of the metal is lower than the concentration of the metal oxide, and metal-oxide areas 110 may surround small islands of metal 108. The ratio between the concentration of the metal and the concentration of the metal-oxide may vary continuously throughout the layer, thus creating a giant solid dispersion layer. Such a construction of the laser-absorbing layer may improve the sensitivity of the printing member in comparison to conventional printing members having a metal layer as explained hereinbelow.

The metal domains positioned in proximity to coating layer 15 may improve the adhesion of the coating layer 15 to the metal/metal-oxide layer.

The metal domains positioned in proximity to base layer 102 may improve the adhesion of the metal/metal-oxide layer to base layer 102. Additionally, those metal domains may reflect some of the laser radiation from base layer 102 back into the laser-absorbing layer 104. The metal regions may also absorb the non-reflected radiation, thus increasing the temperature of the laser-absorbing layer 104. The metal domains may then be sublimated and/or vaporized and/or burned causing the de-anchoring of the laser-absorbing layer together with the coating layer at the selected area.

The metal-oxide domains 110 in proximity to base layer 102 may decrease the thermal conductivity of the laser-absorbing layer 104 and may reduce the thermal drift from the area selected to be laser-radiated to its surroundings.

The structure of the laser absorbing layer according to some embodiments of the present invention may accelerate the imaging process and may improve the sensitivity of the printing plate to the laser energy. Therefore, a printing plate shred according to some embodiments of the present invention may be exposed by a lower energy and/or may be exposed for shorter period of time than a standard printing plate.

According to some embodiments of the present invention, the concentration of the metal within the metal/metal-oxide layer at the bottom of the layer close to base layer 102 may be, for example, in the range of 55% to 95%. According to other embodiments of the present invention, the concentration of the metal within the metal-oxide layer at the bottom of the layer close to base layer 102 may be, for example, in the range of 50% to 90%. The regions of metal near the bottom of laser absorbing layer 104 may improve the adhesion of the layer to base layer 102 and may reflect the laser radiation back into the laser absorbing layer.

According to some embodiments of the present invention, the concentration of the metal within the metal/metal-oxide layer at the top of the layer close to coating layer 15 may be, for example, in the range of 5% to 45%. According to other embodiments of the present invention, the concentration of the metal within the metal/metal-oxide layer at the top of the layer close to coating layer 15 may be, for example, in the range of 10% to 20%.

Alternatively, the concentration of the metal may be higher in the middle of layer 104 while the concentration of the metal-oxide may be higher at both edges of layer 104, namely, at the top close to coating layer 15 and at the bottom close to base layer 102.

Referring back to FIGS. 2, 3 and 4, a coating material may be applied on substrate 14 to form the coating layer 15. The coating material may be prepared on-demand for a single use. Coating layer 15 may be an ink-repelling oleophobic layer comprising silicone epoxy oligomer or silicone acrylate oligomer.

The coating material, which may be a fluid mixture, may comprise liquid polysiloxane substituted with suitable functional groups. Non-limiting examples of suitable functional groups mar be epoxy, acrylate and vinyl. The formulation may comprise photoinitiators to allow cross-linking and/or polymerization by ultraviolet radiation. Other additives, such as, but not limited to adhesive promoters and modifiers to improve the mechanical and surface properties of the coating layer may be added to the formulation.

The coating material according to other exemplary embodiments of the present invention may comprise alternatively or additionally other functional groups, such as, but not limited to, vinyl and silane that may provide cross-linking via addition curing, condensation curing and moisture curing.

### EXAMPLES

There may be many variations to the formulation of the coating material, some of which are given, by way of illustration only, to show certain aspects of the formulations according to some embodiments of the present invention without limiting its scope. In the following examples of the coating formulation, component designations are in weight percentages.

### Example 1

| Weight % | Ingredients of the coating material |
|---|---|
| 73 | Silocone acrylate oligomer, sold under the trade name |
| | of Silcolease PC-900 by Rhodia, Mississauga, USA |
| 21 | Silocone acrylate oligomer, sold under the trade name |
| | of Silcolease PC-970 by Rhodia, Mississauga, USA |
| 3 | Photoinitiator, sold under the trade name of Darocure |
| | 1173 by Ciba Speciality Chemicals, Basel, Switzerland |
| 3 | An adhesion promoter sold under the trade name of |
| | Sartomer 9051 by Cray Valley, Exton, USA |

### Example 2

| Weight % | Ingredients of the coating material |
|---|---|
| 35 | silicons acrylate oligomer, sold under the trade name |
| | of Silcolease PC-970 by Khodia, Mississauga, USA |
| 61 | acrylate monomer, sold under the trade name of Genomer |
| | 1456 by Rahn, Zurich, Switzerland |
| 2 | adhesion promoter, sold under the trade name of |
| | Sartomer 9051 by Cray Valley, Exton, USA |
| 1.4 | photoinitiator, sold under the trade name of Darocure |
| | 1173 by Ciba Speciality Chemicals, Basel, Switzerland |
| 0.6 | photoinitiator, sold under the trade name of Irgacure |
| | 819 by Ciba Speciality Chemicals, Basel, Switzerland |

According to other exemplar embodiments of the present invention, base layer 102 may be an ink-repelling hydrophilic layer and coating layer 15 may be an ink-accepting oleophilic layer. In these embodiments, base layer 102 may be a coated metal layer, which is an ink-repelling hydrophilic layer. Non-limiting examples of hydrophilic base layer 102 may be an anodized aluminum substrate, an aluminum substrate, which may be coated with sodium silicates, polyvinyl phosphonic acid and its salts, copolymers of vinyl phosphonic acid or acrylamide and their salts, a polymer like polyester, which may be coated with polyvinyl alcohols and its copolymers, polyvinyl pyrrolidone and its copolymers and the like. The thickness of the hydrophilic layer 102 may be, for example, in the range between 0.004 inch and 0.02 inch.

In these embodiments, the ink-accepting oleophilic coating layer 15 may comprise UV curable acrylate or epoxy. Non-limiting examples of suitable materials may be polyurethane, polyester and epoxy with a cross linking agent.

It should be noted that the fabrication of the printing members described with respect to FIGS. 2-5, according to some embodiments of the present invention may be performed by other systems and systems 10 and 11 are described by way of example only.

While certain features of the invention have been illustrated and described herein, many modifications, substitutions, changes, and equivalents will now occur to those of ordinary skill in the art. It is, therefore, to be understood that the appended claims are intended to cover ELI such modifications and changes as fall within the true spirit of the invention.

What is claimed is:

1. A lithographic printing member comprising:
a base layer;
a laser-absorbing layer over said base layer, where said laser-absorbing layer is a gradient solid dispersion of metal and metal-oxide areas such that concentration ratios between the metal and the metal-oxide vary throughout a thickness of said laser-absorbing layer; and
a coating layer over said laser-absorbing layer, said coating layer and said base layer having different affinities for ink.

2. The printing member of claim 1, wherein the metal is aluminum and the metal-oxide is aluminum-oxide.

3. The printing member of claim 1, wherein at least some of the metal-oxide areas have a non-stoichiometric ratio between the metal of the metal-oxide and the oxygen such that there are more metal atoms than the stoichiometric ratio.

4. The printing member of claim 3, wherein the non-stoichiometric ratio varies throughout the thickness of said laser-absorbing layer.

5. The printing member of claim 4, wherein the non-stoichiometric ratio is higher in proximity to said base layer than in proximity to said coating layer.

6. The printing member of claim 1, wherein the thickness of said laser-absorbing layer is in the range between 0.02 to 0.6 microns.

7. The printing member of claim 1, wherein the concentration of the metal in proximity to said base layer is higher than the concentration of the metal in proximity to said coating layer.

8. The printing member of claim 1, wherein said coating layer is an ink-repelling layer.

9. The printing member of claim 1, wherein said coating layer comprises an ultraviolet curable material.

10. The printing member of claim 1 further comprising:
a form film over said coating layer.

11. The printing member of claim 10, wherein said form film is a polymeric film with low surface energy.

12. The printing member of claim 1 further comprising:
a primer layer over said laser-absorbing layer.

13. An on-demand plate-making apparatus comprising:
a substrate holder to hold a substrate, said substrate comprising a base layer and a laser-absorbing layer;
a dispensing unit to prepare a coating material; and
a coating unit to apply said coating material onto said substrate to form a coating layer,
wherein said coating layer and said base layer have different affinities for ink.

14. The apparatus of claim 13, wherein said substrate holder is a substrate-feed roller.

15. The apparatus of claim 13, wherein the dispensing unit is a multi-compartment cartridge.

16. The apparatus of claim 11, wherein the coating unit comprises a form film holder and a guide roller to guide the form film such that the coating material is trapped between the substrate and the form film.

17. The apparatus of claim 13, further comprising:
an ultraviolet lamp.

18. The apparatus of claim 13, further comprising:
a cutting unit to cut the substrate in two dimensions.

19. The apparatus of claim 13, wherein said laser-absorbing layer is a gradient solid dispersion of metal and metal-oxide areas such that concentration ratios between the metal and the metal-oxide vary throughout a thickness of said laser-absorbing layer.

20. A method comprising:
guiding a form film and a substrate where said substrate comprising a base layer and a laser-absorbing layer to an area of convergence;
supplying a liquid-based coating material to said area of convergence; and
laminating said form film, said liquid-based coating material, and said substrate to form a coating layer over said substrate,

21. The method of claim 20, wherein said coating layer and said base later have different affinities for ink.

22. The method of claim 20 finer comprising:
radiating said coating layer with ultraviolet radiation.

23. The method of claim 20 further comprising:
preparing on demand for a single use said liquid-based material.
